(19) United States
(12) Patent Application Publication
(10) Pub. No.: US 2014/0243032 A1
(43) Pub. Date: Aug. 28, 2014

(54) Site Scan for Mobile Base Stations

(71) Applicant: NXP B.V., Eindhoven (NL)

(72) Inventor: Jaijith Kurichiyil Karipurillum Radhakrishnan, Bangalore (IN)

(73) Assignee: NXP B.V., Eindhoven (NL)

(21) Appl. No.: 14/174,150

(22) Filed: Feb. 6, 2014

(30) Foreign Application Priority Data
Feb. 28, 2013 (IN) 588/DEL/2013

(51) Int. Cl. H04W 40/24; H04W 24/08

(52) U.S. Cl. CPC H04W 40/246; H04W 24/08
USPC 455/515

(57) ABSTRACT

A method of determining interconnections between at least two components in a base station. The at least two components connected to each other and any further components by one or more ports and the method comprising the steps of; in response to receipt of an interrogation message at a port of one of the components, replying to said interrogation message with a response message, said response message including identification information of said component in receipt of the interrogation message.

### RELATED APPLICATIONS

This application claims priority from Indian application no. 588/DEL/2013 and its contents is incorporated herein by reference.

### FIELD OF THE INVENTION

The invention relates to method for scanning a base station. In particular, it relates to a method for determining the connectivity between a plurality of components in a base station.

### BACKGROUND OF THE INVENTION

Connections within a base station are normally inspected at the time of installation and commissioning of the base station. This is usually done by visual inspection and, typically, does not comprise an electrical test of the connections. Such visual inspections are prone to human error and are time consuming. After commissioning, if there are any issues, operators need to bring the base station to a non-operational state and debug the issues. The performance or integrity of equipment and connections can degrade over time. Degrading connectivity such as damage to ALD (Antenna Line Devices), base station equipment, connectors or cables cannot be assessed by visual inspections and detailed site inspections are required. When there are issues such as these it may require multiple base station site visits to resolve them. These factors increase the maintenance cost of the base station.

It should be mentioned here that there is no method defined in industry to automatically scan for connectivity issues and make this data remotely available to operation and maintenance centers.

Antenna Standards Interface Group (AISG) is a standard that addresses equipment failure and tuning parameters of ALD for efficient operation of the network. It does not address issues of connectivity between different components at the base station or that are mounted on a tower of the base station. The object of one aspect of the invention is to efficiently address this issue by providing a system and method that enables a smart network operation and maintenance center to obtain connectivity information from a base station at a remote location.

A base station facilitates wireless communication, such as in a mobile telecommunications network. A base station typically includes a plurality of components for providing a wireless communication service such as one or more of each of an antenna, an amplifier, a remote electrical tilt device, a filter and a controller. For example, a base station comprises, inter alia, devices sitting on and/or associated with a tower including but not limited to a Tower mounted amplifier (TMA), an Antenna, Remote electrical tilt (RET), filters, Base station controllers (BSC), Base transceiver station (BTS). It will be appreciated that other components may be present in the base station for providing the wireless communication service. The components are typically interconnected as required.

### SUMMARY OF THE INVENTION

Hence, there is a need, to find a method and apparatus for scanning base stations to remotely assess connectivity between components of the base station. It is therefore an object of the invention to provide an automated testing of the connectivity of the base station. Each component of the base station may be considered to comprise at least one port which provides a connection to corresponding ports of other components of the base station. The invention may be considered an extension of the AISG standard, although it will be appreciated that the invention may be implemented as a separate standard or method. Further, the invention may provide an extension to the functionality of AISG communication modems/controllers but can equally be implemented with any communication devices in the components of the base station that allow connectivity assessment messages to be routed through the components.

It is further admitted that all the ports including RF and AISG ports allow point to point access of all the ports required. It is further admitted that the devices subject to scanning are capable of receiving and/or transmitting AISG messages through their ports.

According to a first aspect of the invention we provide a method of testing a base station comprising a base station controller coupled to a set of secondary devices, comprising the steps of:
configuring the secondary devices in a repeater mode;
performing the scan while AISG connections are active.

The step of configuring the secondary devices comprise the steps of
disconnecting the secondary devices from the normal AISG scan,
connecting the devices via AISG controllers in a testing mode.

In the testing mode, the AISG controllers are configured to act on connectivity messages. The normal mode of operation of the base station is shown in FIG. 1. The figure shows only AISG related connectivity for a TMA in normal AISG operation including address scan mode. RF connectivity is not shown. This connectivity is practically a bus and many devices are connected to the same bus. Here TMA is one such secondary device and the primary device BSC is connected to the port ‘0’ and RET may be connected to port ‘2’.

Throughout the description a “port” is a cable connection between components, such as the tower mounted devices, which are capable of performing the site scan method

All “Site Scan” enabled devices may be aware of how many ports they have and the attributes of these ports. With the connectivity information and attributes of the ports, it is possible to run lot of diagnostics from the remote operation and maintenance center.

The scan can be initiated from the Base Station Controller (BSC) or remotely such as from a central operation and maintenance center. To evaluate connection problems such as open and wrong connections the scan initiator needs to know the intended connectivity of base station. The method may include the step of cross checking the detected connectivity with the intended connectivity. The intended connectivity may be received from a data store. Thus, the method may identify the actual connectivity to evaluate deviation from the intended connectivity to find bad/wrong connections.

Alternatively, the detected connectivity may be cross-checked against a set of connection rules to check if any rule is violated. For example, a rule can be “an RF output port should not be connected to other RF output port” OR “TMA port and antenna port need to be in same band of operation” etc. Once the connections have been detected or while the connections are being determined the method may check the connections against the connection rules.

The step of connecting the devices via AISG controllers in a testing mode comprises cross connecting transmission/reception ports or store and forward from receiving ports to transmission ports.

According to a further aspect of the invention we provide a method of determining interconnections between at least two components in a base station, the at least two components connected to each other and any further components by one or more ports, the method comprising the steps of;
in response to receipt of an interrogation message at a port of one of the components, replying to said interrogation message with a response message, said response message including identification information of said component in receipt of the interrogation message.

The response message may include a report of the number of ports present in the component in receipt of the interrogation message. The response message may include information identifying the port of the component at which the interrogation message was received. The response message may be sent from the same port that received the interrogation message.

The method may include the step of;
in response to receipt of a repeat request message at one of the components, configuring the component to repeat or forward messages received at a first port to a second port, different to the first port.

The repeat request message may include an instruction of the port to which subsequent messages should be repeated or forward to. Thus, the component may be instructed by the repeat request message to repeat or forward messages received at a first port of the component to one (or more) of the other ports of the component.

The method may include the step of;
in response to receipt of a repeat request message, said repeat request message including a request for messages to be repeated or forwarded to a particular port different to the port that received the repeat request message, replying to said repeat request message with a repeat request success message indicating that subsequent messages will be repeated or forwarded to the particular port.

The method may include the step of;
in response to receipt of a repeat request message, said repeat request message including a request for messages to be repeated or forwarded to a particular port different to the port that received the repeat request message, replying to said repeat request message with a repeat request failure message if a link between the port of the component that received the repeat request message and the particular port of the component requested by the repeat request message cannot be made. For example, the component may not have the capability to form a direct internal communication link between those ports. In this instance, the component may report back to indicate such a link is not possible.

The method may include the step of;
following receipt of a repeat request message, repeating or forwarding an interrogation message received at the first port to the particular port instructed in the repeat request message.

The method may include the step of;
following receipt of a repeat request message, repeating or forwarding a response message received at the particular port to the first port.

It will be appreciated that the first port may be any of the ports of the component that received the repeat request message and is not necessarily “the first port” as designated by said component. The method may include the step of remotely initiating the sending of the interrogation message from one of the components to another of the components in the base station from a control center remote from the base station. The method may include the step of remotely initiating the sending of a repeat request message from one of the components to another of the components in the base station from a control center remote from the base station. Thus, a control center geographically remote from the components of the base station may initiate or control the method to determine the interconnections between the components. Thus, the method may include the step of reporting at least one discovered interconnection between the components to the control center.

According to a further aspect of the invention we provide a component for forming a component part of a base station, the component configured to be connected to other components by one or more ports, the component configured to;
in response to receipt of an interrogation message, reply to said interrogation message with a response message, said response message including identification information of said component.

The response message may include one or more of the following;
a report of the number of ports present in the component; and
information identifying the port at which the interrogation message was received.

The component may be configured to send the response message from the same port that received the interrogation message.

The component may be configured to, in response to receipt of a repeat request message that requests the component to repeat or forward messages to another one of its ports, configure a communication link between a first port at which the repeat request message is received and a second port, different to the first port.

Thus, the component may include a controller, such as an AISG controller, for configuring links between ports of the component in response to repeat request messages. It will be appreciated that the links may be virtual internal links between the ports.

The repeat request message may include an instruction of the particular port to which subsequent messages should be repeated or forward to and the component may be configured to form a link between the port at which the repeat request message was received and the particular port.

The component may be configured to, in response to receipt of a repeat request message, said repeat request message including a request for messages to be repeated or forwarded to a particular port different to the port that received the repeat request message, make a link between the ports and reply to said repeat request message with a repeat request success message indicating that a link has been established and subsequent messages will be repeated or forwarded to the particular port.

The component may be configured to, in response to receipt of a repeat request message, said repeat request message including a request for messages to be repeated or forwarded to a particular port different to the port that received the repeat request message, reply to said repeat request message with a repeat request failure message if a link between the port that received the repeat request message and the particular port requested by the repeat request message cannot be made.

The component may be configured to, following receipt of a repeat request message, repeat or forward a received interrogation message to the particular port instructed in the repeat request message.

The component may be configured to, following receipt of a repeat request message, repeat or forward a response message received at the particular port to a different component. This is advantageous as the component that sent the repeat request message will receive the response due to the links established in each component through which the messages travel. Thus, no addressing is required as the links provide a “direct” communication channel to and from the component performing the connectivity scan.

According to a further aspect of the invention we provide a controller component for forming a component part of a base station, the controller component configured to be connected to other components by one or more ports, the controller component configured to;
send an interrogation message to one of the other components of the base station, the interrogation message requesting at least identification information from the other component.

The interrogation message may request at least one of;
a report of the number of ports present in the other component;
information identifying the port of one of the other components at which the interrogation message was received.

The controller component may be configured to send a repeat request message requesting one of the other components to repeat messages sent by said controller component to a different port from the port that received the message.

The controller component may be configured to receive response messages in response to said interrogation messages, and wherein said controller component uses said response messages to derive a connectivity record comprising the interconnections between the ports of the controller component and other components. It will be appreciated that the controller component may be configured to send the response messages to a remote operation and maintenance center and the connectivity record may be derived by said operation and maintenance center.

According to a further aspect of the invention, we provide a base station comprising a first component and at least one secondary component, the first and secondary components connected together for providing an RF communication channel for providing a wireless communication service, wherein the first component comprises a controller component, the controller component configured to send at least one interrogation message requesting identification information from the secondary components, the secondary components configured to respond to the interrogation message with a response message, the controller component configured to receive said response message for deriving the connectivity between the components.

The base station may include a controller, such as an AISG controller, configured to reconfigure internal links between ports in the secondary devices and repeat messages received from the controller component along said links. Thus, the messages may be repeated by storing and forwarding the messages or allowing said messages to pass through said component along said link. Each component may include connectivity determination controller, such as an AISG controller, to process and respond to connectivity assessment messages.

### BRIEF DESCRIPTION OF THE DRAWINGS

The above and other advantages will be apparent from the exemplary description of the accompanying drawings in which

FIG. 1 shows an example arrangement of a base station having a plurality of components in communication with a remote operation and maintenance center;

FIG. 2a depicts an example tower Mounted Amplifier (TMA) during normal AISG scan;

FIG. 2b depicts an example tower mounted amplifier (TMA) in repeater mode;

FIG. 3 depicts the legend of the signs used in the next figures;

FIG. 4 depicts an example of a site scan sequence for determining the connectivity between components in the base station of FIG. 1;

FIGS. 5 to 16 depict a continuation of the example method of FIG. 4;

FIG. 17 depicts an example format for storing information;

FIG. 18 depicts an example debugging sequence; and

FIG. 19 depicts an example complete scan and debug sequence.

### DETAILED DESCRIPTION OF EMBODIMENTS

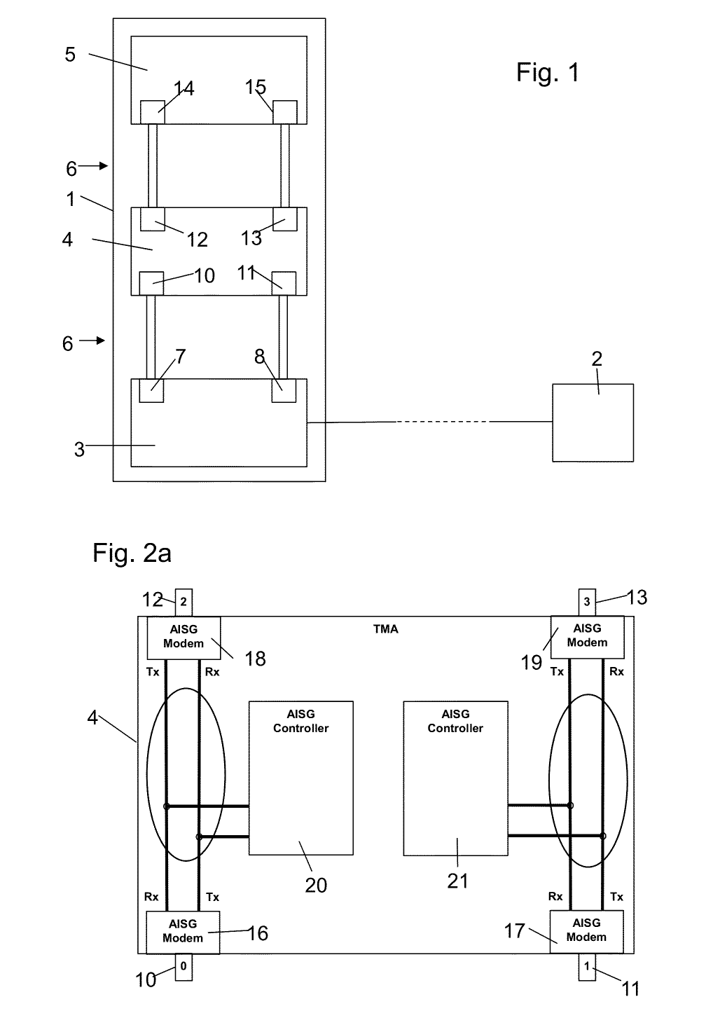

FIG. 1 shows an example base station 1 for providing a wireless communications service. The base station 1 has a connection to a remote operation and maintenance center 2, which can remotely control and monitor said base station 1 using, for example, the AISG standard (Antenna Interface Standards Group).

The base station 1 comprises a plurality of distinct components 3, 4, 5 which provide functionality for the base station. The components are Antenna Line Device components. The components have interconnections 6 therebetween to functionally connect the components together. In this example, component 3 comprises a base station controller component. The controller component may be responsible for handling traffic and signaling between a mobile phone and the network switching subsystem. The controller component 3 is connected to the component 4, which comprises a tower mounted amplifier (TMA) component. The TMA 4 is configured to amplify a RF signal received by the base station 1. The TMA 4 is connected to the component 5 which comprises a remote electrical tilt (RET) component. The RET component 5 is configured to electrically modify the direction of a radiation pattern of an antenna of the base station.

Each component is connected to the other components by a plurality of ports. The base station controller 3 has two ports 7, 8. The TMA 4 has four ports 10, 11, 12, 13. The RET 5 has two ports 14, 15. It will be appreciated that the base station may comprise other components or other combinations of components. Further, the components may have different numbers of ports and may have different interconnections depending on the particular configuration of the base station 1. However, in this example, the two ports 7, 8 of the base station controller 3 connect to two corresponding ports 10, 11 of the TMA 4. The other two ports 12, 13 of the TMA 4 are connected to two corresponding ports 14, 15 of the RET 5. In the following example the base station controller component 3 is responsible for issuing the messages to discover the interconnection between the components and can therefore be considered to be a primary device. The TMA 4 and REC 5 are configured to reply to messages from the primary device and forward messages/replies from other components. Thus, they can be considered to be secondary devices.

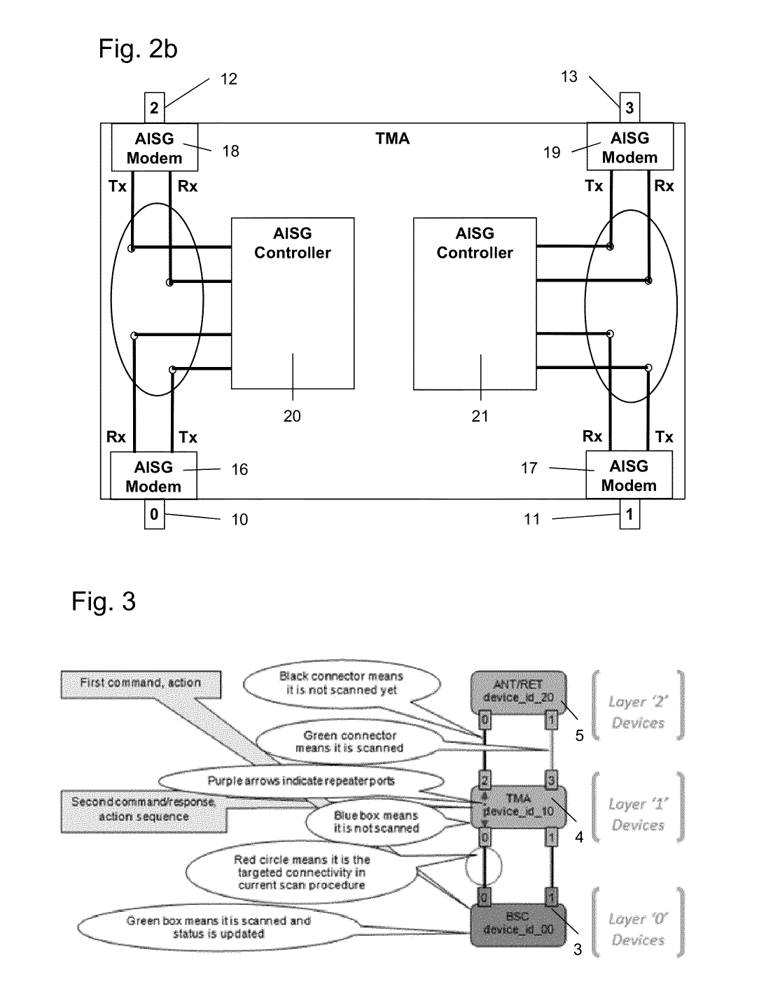

FIG. 2a shows an example of one of the components 3, 4, 5 and, in particular, in this example, the TMA 4. The TMA 4 has four ports 10, 11, 12, 13 having an internal designation of 0 through to 3. Each port is associated with an AISG modem 16, 17, 18, 19 used to provide communication into and out of the component for connectivity assessment messages/AISG messages. The AISG modems 16, 17, 18, 19 each provide an interface between their associated port and a transmit channel and a receive channel. The component 4 further has at least one component controller. In this example, two component controllers 20, 21 are provided which comprise AISG controllers. The AISG controllers 20, 21 are configured to respond to connectivity assessment messages/AISG messages, which will be described in more detail below, and reconfigure the internal transmit/receive channels to form links between the ports of the component. It will be appreciated that these links may be formed by repeating messages received at one port to another, which may include virtual or physical links, storing and forwarding or any other appropriate way of relaying a message between ports. The reconfiguring of the AISG links between ports allows the connectivity between the components to be determined in accordance with the example method described below.

FIG. 2a shows the component 4 in an AISG monitoring mode. The AISG controller 20 is monitoring the transmission and receive channels between ports “0” and “2” and AISG controller 21 is monitoring the transmission and receive channels between ports “1” and “3”.

FIG. 2b shows the component 4 in a repeater mode in which the controller can actively route messages received at one port to one or more of the other ports. Such routing may be established in response to the AISG controllers 20, 21 receiving a repeat request message.

The figure shows only AISG related connectivity or “links” for a TMA in “Site Scan” repeater mode. RF connectivity is not shown. This connectivity is point to point bus connectivity. Secondary devices respond to commands addressed to it, or it repeat the command/response to another port. The arrows in the diagrams mean either the crossed transmit (Tx) and receive (Rx) links or Store and forward from Rx to Tx, as will be explained in the following figures.

FIG. 3 depicts the legend of the signs used in the next figures. It is self-explanatory and no other comments are necessary.

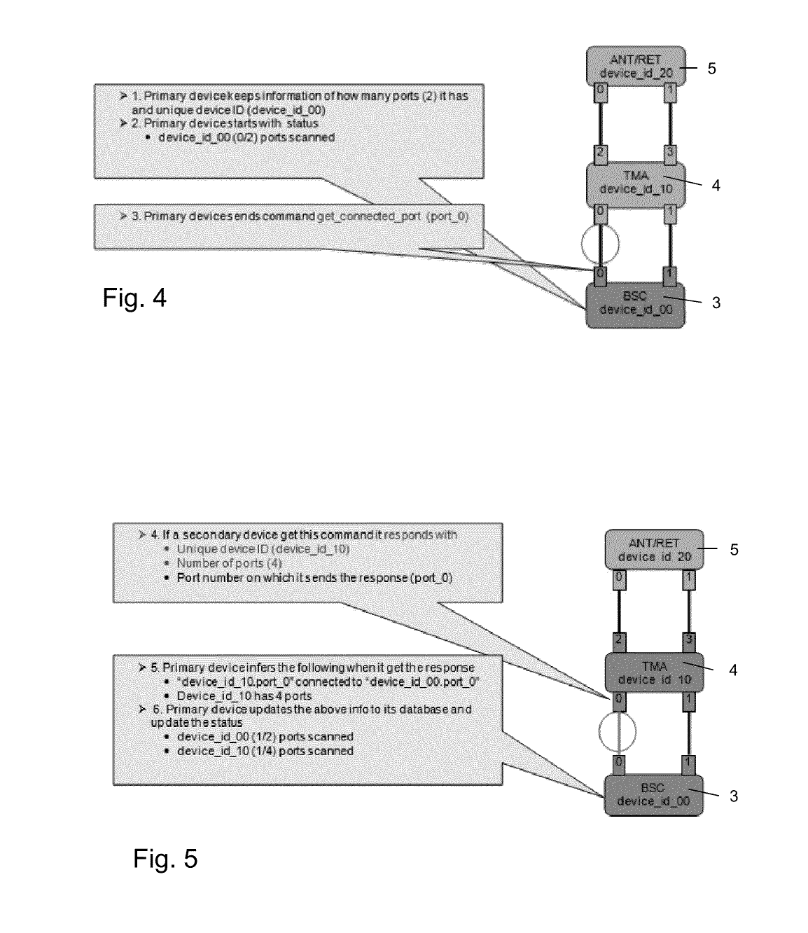

FIGS. 4 through to 16 describe the steps taken in an example “Site Scan” to identify the interconnections between components 3, 4, 5 at the base station. The scan sequence is numbered 1 to 13 but does not necessary have to be performed in that order. The scan may be performed to check interconnections once the base station is commissioned or may be performed to identify problem interconnections during operation. The site scan is typically initiated remotely from the remote operation and maintenance center 2, although it may be initiated by a component of the base station 1. The method can be considered to assign responsibility to one of the components for sending messages to the other components to discover the interconnections. In this example, the base station controller “BSC” component 3 is given the responsibility of issuing the messages and is considered to be a primary device. The other components are thus considered to be secondary devices. Further, FIGS. 4 to 16 show the BSC 4 in “layer 0” and the TMA 4, directly connected to the BSC 4 in “layer 1”, which is one step away from the BSC 3. The RET component 5 is in “layer 2” which is two steps away from the BSC 4, i.e. a message from the BSC 4 must pass through one other component to reach it, therefore passing through two interconnections 6.

The secondary devices 4, 5 are configured to reply to an interrogation message and reconfigure their internal links between ports in response to a repeat request message. Further, the secondary devices are programmed with identification information to uniquely identify themselves in the base station and have knowledge of the number of ports they have and whether or not it is possible to form a link between each pair of ports.

FIG. 4 depicts the site scan sequence 1. It comprises the steps of

1. The primary device, comprising base station controller component 3, keeps information of how many ports (2) it has and its unique device ID (device_id_00)

2. Primary device starts with a “status” record of;
device_id_00 (0/2) ports scanned

which specifies that the primary device has scanned zero of its two ports.

3. Primary device sends a message/command get_connected_port (port_0)
“get_connected_port” comprises an interrogation message for discovering what is connected to a port, which, in this step, is discovering what is connected to port_0 of BSC 3.

FIG. 5 depicts the site scan sequence 2 comprising the steps of;

4. If a secondary device get this command or “interrogation message” it responds with a response message. The response message comprises the following information;
Unique device ID (device_id_10), which comprises the identification information of the TMA 4.
Number of ports (4), which comprises the predetermined number of ports that component 4 has.
Port number on which it sends the response (port_0), which comprises the port belonging to the component 4, used to send the response message. This port is the same as the port that received the interrogation message.

5. The Primary device 3 infers the following when it get the response, which it adds to its connectivity database.
“device_id_10.port_0” connected to “device_id_00.port_0”. Thus, the BSC 3 has discovered that its port 0 is connected to port 0 of a component with the identification name of “device_id_10”, namely TMA 4.
Device_id_10, i.e. TMA 4, has 4 ports.

6. The primary device 3 appends the above discovered information to its database and updates its status. The status provides a record of the progress of the scan. Thus, the status records that one of the BSCs two ports have been scanned and one of the TMAs four ports has been scanned.device_id_00 (1/2) ports scanned
device_id_10 (1/4) ports scanned

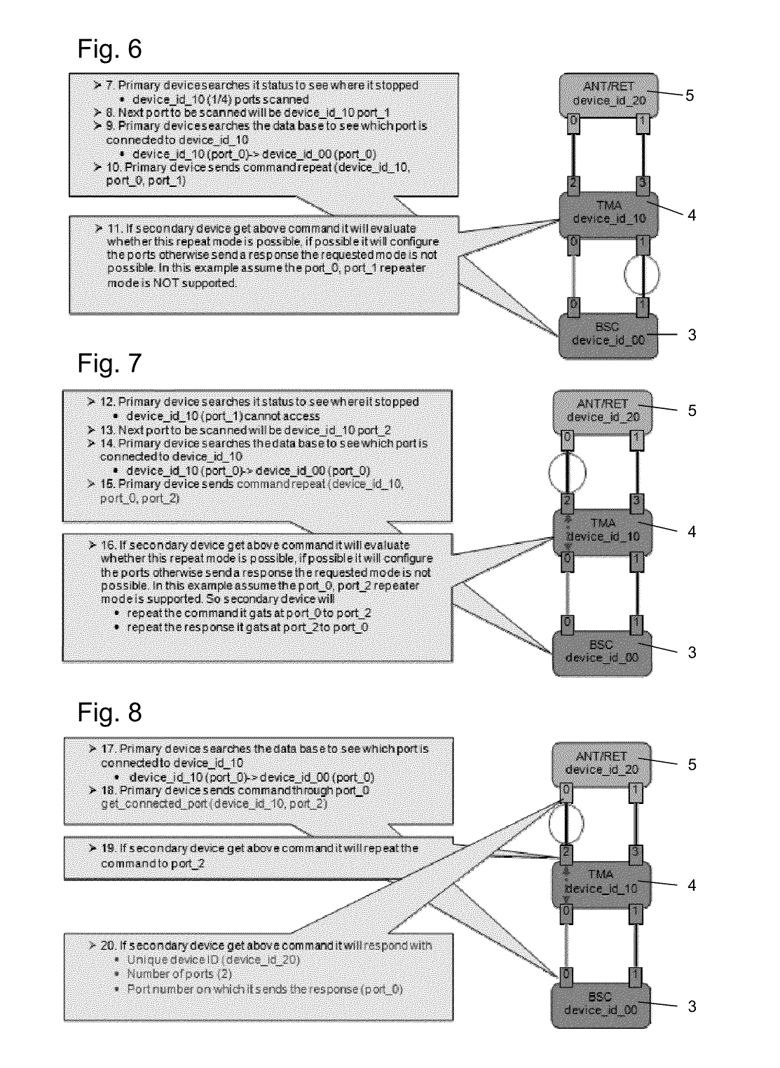

FIG. 6 depicts the site scan sequence 3 comprising the steps of;

7. The primary device searches its status record to see where it stopped i.e. the current progress of the scan.
device_id_10 (1/4) ports scanned

8. The scan is configured to proceed by scanning the next port of the newly discovered TMA 4. Thus, the next port to be scanned will be device_id_10 port_1, namely port 1 of the TMA 4.

9. The primary device 3 searches the connectivity database to see which of its ports is connected to device_id_10 (TMA 4)
device_id_10 (port_0)→device_id_00 (port_0), which shows that port 0 of TMA 4 is connected to port 0 of BSC 3. Thus, the BSC 3 uses its port 0 to send the next message, which comprises a repeat request message.

10. The primary device sends the message repeat (device_id_10, port_0, port_1)

11. If secondary device gets above “repeat request message” it will evaluate whether this repeat mode is possible, i.e. is it possible for an internal link to be established between port 0 and port 1 in TMA 4. If possible it will configure the ports otherwise it is configured to send a response message stating that the requested repeat mode is not possible. In this example the port_0, port_1 repeater mode is NOT supported. As can be seen from FIGS. 2a and 2b, two AISG controllers 20, 21 are provided each serving two ports each. “Port 0” is connected to the first AISG controller 20 and “port 1” is connected to the second AISG controller 21. Thus, the AISG controller 20 that receives the repeat request message is not able to form a link with “port 1”.

FIG. 7 depicts the site scan sequence 4 comprising the steps of;

12. The primary device searches it status to see where it stopped
device_id_10 (port_1) cannot access

This indicates that it has not yet been possible to access port 1, the second port, of component 4.

13. The method proceeds to the next port to be scanned, which is the third port of the TMA component 4—device_id_10 port_2

14. The primary device searches its data base to see which port is connected to device_id_10, the TMA component 4.
device_id_10 (port_0)→device_id_00 (port_0), which shows that port 0 of TMA 4 is connected to port 0 of BSC 3. Thus, the BSC 3 uses its port 0 to send the next message, which comprises a repeat request message.

15. Primary device sends the repeat request message: repeat (device_id_10, port_0, port_2), which requests that the TMA 4 forms a link between its port_0 and its port_2.

16. If TMA 4 receives the above message it will evaluate whether this repeat mode is possible, if possible it will configure the ports otherwise send a response the requested mode is not possible. In this example the port_0, port_2 repeat mode is supported. Thus, a link between port_0 and port_2 is formed by the AISG controller 20. Thus, the TMA 4 will
repeat messages it receives at port_0 to port_2
repeat the message responses it receives at port_2 to port_0

FIG. 8 depicts the site scan sequence 5 comprising steps of;

17. The primary device, BSC 3, now wishes to determine what is connected to port 2 of the TMA 4. Thus, it searches its data base to see which port is connected to device_id_10 (TMA 4)
device_id_10 (port_0)→device_id_00 (port_0)

18. The primary device thus sends an interrogation message through port_0 of the BSC 3 comprising—get_connected_port (device_id_10, port_2), which asks what is connected to port 2 of the TMA 4.

19. If the secondary device (TMA 4) gets above command it will repeat the command to port_2, as established in step 16.

20. If the secondary device RET 5 receives the above interrogation message it will respond with a response message, which includes;
Its unique device ID (device_id_20)
The number of ports it has (2)
Port number on which it sends the response (port_0)

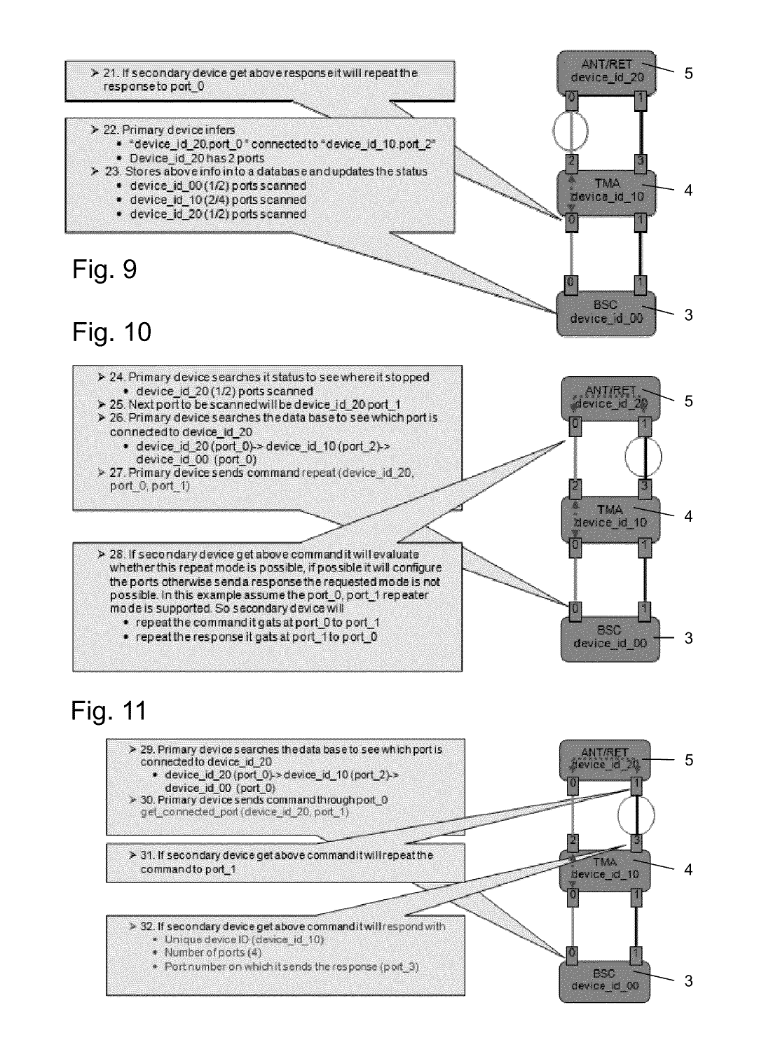

FIG. 9 depicts the site scan sequence 6 comprising steps of;

21. The TMA 4 is in repeat mode and therefore when the TMA 4 receives the above response message it will repeat the response to its port_0

22. The primary device, BSC 3, on receiving the response message, infers
“device_id_20.port_0” connected to “device_id_10.port_2”, i.e. port 0 of the RET 5 is connected to port 2 of the TMA 4.
Device_id_20 has 2 ports, i.e. the RET 5 has two ports.

23. The BSC 3 stores the above information in its connectivity database and updates the status
device_id_00 (1/2) ports scanned, which indicates that of the BSC 3, one of its two ports has been scanned
device_id_10 (2/4) ports scanned, which indicates that of the TMA 4, two of its four ports have been scanned
device_id_20 (1/2) ports scanned, which indicates that of the RET 5, one of its two ports has been scanned

FIG. 10 depicts the site scan sequence 7 comprising steps of;

24. The primary device, BSC 3 searches its status to see where it stopped
device_id_20 (1/2) ports scanned, which states that one of the two ports of RET 5 has been scanned.

25. The method proceeds to the next port to be scanned, which is in this embodiment the second port 15 “port_1” of the RET 5—device_id_20 port_1

26. The primary device searches the data base to see which port is connected to device_id_20
device_id_20 (port_0)→device_id_10 (port_2)→device_id_00 (port_0), which indicates that port_0 of the RET 5 is connected to port_2 of the TMA 4, which is connected to port_0 of the BSC 3.

27. The primary device BSC 3 sends a repeat request message—repeat (device_id_20, port_0, port_1), which requests that the RET 5 repeat messages received at its port_0 to its port_1.

28. If the RET 5 receives the repeat request message it will evaluate whether this repeat mode is possible, if possible it will configure the ports otherwise send a response the requested mode is not possible. In this example the port_0, port_1 repeater mode is supported. Thus, the AISG controller of the RET forms a link between its port 0 and its port 1. So, the RET 5 will
repeat message it receives at port_0 to port_1
repeat response messages it receives at port_1 to port_0

FIG. 11 depicts the site scan sequence 8 comprising steps of;

29. The BSC 3, now the repeat request message has been sent, wishes to determine what is connected to port_1 of the RET 5. The BSC 3 searches the data base to see which port is connected to the RET 5 “device_id_20”
device_id_20 (port_0)→device_id_10 (port_2)→device_id_00 (port_0), which indicates that port_0 of the RET 5 is connected to port_2 of the TMA 4, which is connected to port_0 of the BSC 3.

30. The BSC 3 sends an interrogation message through port_0 comprising get_connected_port (device_id_20, port_1), which asks what is connected to port_1 of the RET 5.

31. If the RET 5 receives the interrogation message, which will have been repeated by TMA 4, the AISG controller of the RET 5 will repeat the interrogation message to port_1

32. If a secondary device, comprising TMA 4 in this example receives the interrogation message it will respond with a response message comprising
Its unique device ID (device_id_10)
The number of ports it has (4)
The Port number on which it sends the response (port_3)

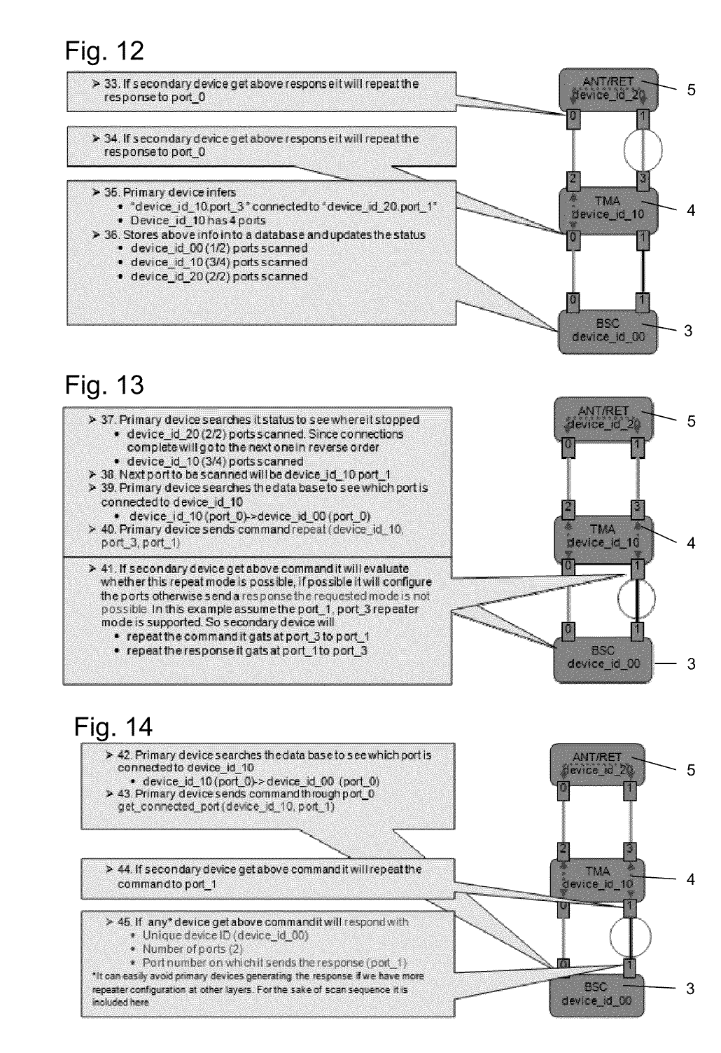

FIG. 12 depicts the site scan sequence 9 comprising steps of;

33. The secondary device RET 5 receives the response message and it will repeat the response to its port_0

34. The secondary device TMA 4 receives the response message and it will repeat the response to its port_0

35. The primary device BSC 3 infers
“device_id_10.port_3” connected to “device_id_20.port_1”, i.e. port 3 of TMA 4 is connected to port 1 of the RET 5.
Device_id_10 has 4 ports, i.e. the TMA 4 has four ports, which was already known to the BSC 3.

36. The inferred information is stored in to the connectivity database and the BSC 3 updates the status
device_id_00 (1/2) ports scanned, which indicates that of the BSC 3, one of its two ports has been scanned
device_id_10 (3/4) ports scanned, which indicates that of the TMA 4, three of its four ports have been scanned
device_id_20 (2/2) ports scanned, which indicates that of the RET 5, two of its two ports have been scanned

FIG. 13 depicts the site scan sequence 10 comprising steps of;

37. The BSC 3 comprising the primary device searches it status to see where it stopped
device_id_20 (2/2) ports scanned. Since all of the ports of the RET 5 have now been scanned the method proceeds to the next secondary device, TMA 4, in a layer one closer than the layer of RET 5. The status of the TMA 4, with reference to the status record, is;
device_id_10 (3/4) ports scanned

38. The next port to be scanned will be device_id_10 port_1, i.e. port_1 of the TMA 4.

39. The BSC 3 searches the data base to see which port is connected to device_id_10, the TMA 4
device_id_10 (port_0)→device_id_00 (port_0), which indicates that port_0 of the TMA 4 is connected to port_0 of the BSC 3.

40. The BSC 3 sends repeat request message comprising repeat (device_id_10, port_3, port_1), which asks the TMA 4 to repeat messages received at its port 3 to its port 1. The repeat request messages will be forwarded to port 3 of the TMA via port 0 of the TMA 4, port 2 of the TMA 4, port 0 of the RET 5, and port 1 of the RET 5.

41. If the secondary device TMA 4 receives the repeat response message it will evaluate whether this repeat mode is possible, if possible it will configure the ports otherwise send a response the requested mode is not possible. In this example the port_1, port_3 repeater mode is supported as AISG controller 21 can form a link between port 3 and port 1 in the TMA 4. So the TMA 4 will
repeat the messages it receives at port_3 to port_1
repeat the message response it receives at port_1 to port_3

FIG. 14 depicts the site scan sequence 11 comprising steps of;

42. The BSC 3 now is configured to send an interrogation message to port 1 of the TMA 4. Thus, the BSC 3 searches the data base to see which port is connected to device_id_10
device_id_10 (port_0)→device_id_00 (port_0), which indicates that port_0 of the TMA 4 is connected to port_0 of the BSC 3.

43. The BSC sends the interrogation message through port_0 comprising get_connected_port (device_id_10, port_1), which asks what is connected to port 1 of the TMA 4.

44. The interrogation message is repeated by TMA 4 to port 0 of RET 5 and then back to TMA 4 via port 1 of RET 5. The TMA 4 then repeats the interrogation message from its port_3 to its port_1. The interrogation message is this received at port 1 of the primary device, BSC 3.

45. On receiving the interrogation message, the BSC 3 sends a response message comprising
The unique device ID (device_id_00)
The number of ports it has (2)

The port number on which it sends the response (port_1) We can easily avoid primary devices generating the response if we have more repeater configuration at other layers. For the sake of scan sequence it is included here.

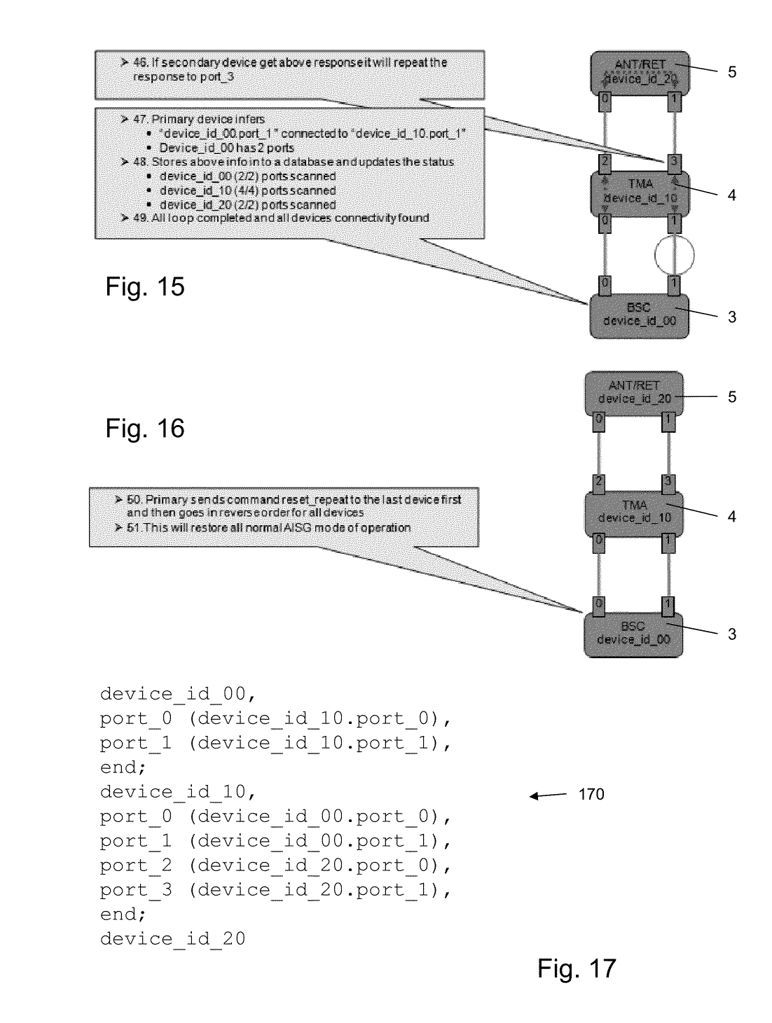

FIG. 15 depicts the site scan sequence 12 comprising steps of;

46. The TMA 4 will receive the response message from the BSC 3 and it will repeat the response to port_3 and so on through RET 5 and TMA 4 back to BSC 3.

47. The primary device BSC 3 infers
“device_id_00.port_1” connected to “device_id_10.port_1”, i.e. port 1 of the BSC 3 is connected to port 1 of the TMA 4.
Device_id_00 has 2 ports, i.e. the BSC 3 has two ports.

48. The BSC 3 stores the above information in to its connectivity database and updates the status
device_id_00 (2/2) ports scanned
device_id_10 (4/4) ports scanned
device_id_20 (2/2) ports scanned

49. All loops have been completed and all device connectivity has been found

FIG. 16 depicts the site scan sequence 13 comprising steps of;

50. The BSC 3 sending a repeat cancel message to the last device first and then sending further repeat cancel messages to the other component AISG controllers in reverse order. Thus, the repeat link between port 3 and port 1 of the TMA 4 is cancelled first, followed by the link between port_1 and port_0 of the RET 5, followed by the link between port 2 and port 0 of the TMA 4.

51. This will restore all normal AISG mode of operation.

It will be appreciated that the above method may specifically be performed by AISG controllers (of which each component has at least one) that send the messages and establish the repeat links. The solution presented in FIGS. 3, . . . , 16 can be extended to any layer or number of layers. The above solution can be extended to any number of devices in one layer. If there is multiple vertical connectivity then the BSC 3 will scan it in turn following the above method.

Using the above-described concept, any complexity of interconnections between components can be covered. The scan procedure needs to be systematic to cover all the possibilities. By setting the rules or by having the information of the intended connectivity and bad or inconsistent connections can be determined.

FIG. 17 depicts a format 170 for storing information in the connectivity database derived by the BSC 3 or its AISG controller. It will be appreciated that the connectivity information can be stored in many formats. One of such ways is in a ‘netlist’ format. This information can be send to the operation and maintenance center 2 for connectivity evaluation and debug purposes.

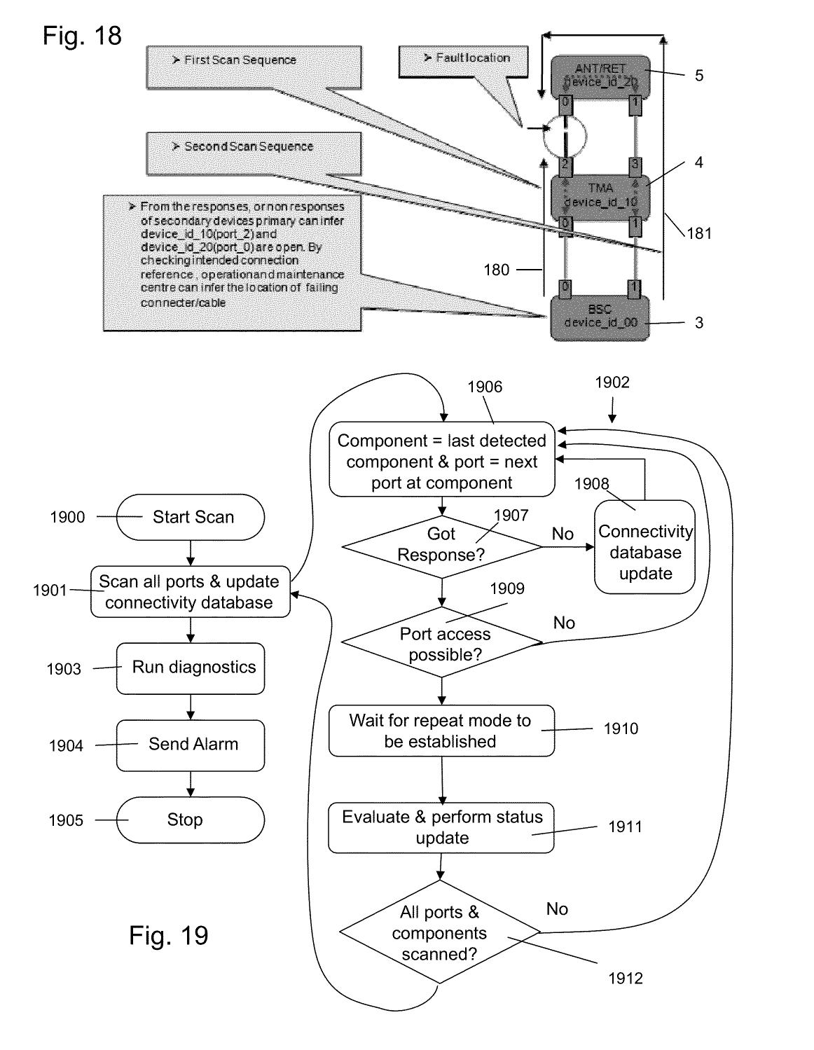

FIG. 18 depicts a debugging sequence for a broken interconnection between port 0 of the RET 5 and port 2 of the TMA 4. From the responses, or non-responses of secondary devices, TMA 4 and RET 5, the primary device, BSC 3 can infer device_id_10 (port_2) and device_id_20 (port_0) are open. Port 2 of the TMA 4 is shown by arrow 180 as being scanned by the BSC 3 through its port_0, which connects to port_0 of the TMA 4 and a repeat link within the TMA 4 between its ports 0 and 2. Arrow 181 shows how Port 0 of the RET 5 is scanned by the BSC 3 by way of port 1 of the BSC 3 which connects to port 1 of the TMA 4, a repeat link in the TMA 4 between its ports 1 and 3, port 1 of the RET 5 and a repeat link between port 1 and port 0 in the RET 5. The connectivity database can be forwarded by the BSC 3 to the operation and maintenance center 2. The database will show that no response message was received in response to interrogation messages sent to port 2 of the TMA 4 and to port 0 of the RET 3. A record of the intended interconnections between the components of the base station 1 can be referenced at the operation and maintenance center 2 and therefore the location of failing connecter/cable/interconnection can be determined.

In the above mentioned scan sequence example, when a new sequence starts it may look for the last non completed device and next port in the incremental order. The sequence of this scan is not important, if the device is capable of repeater mode connection, following a particular port sequence and device sequence will trace all connections. As a minimum requirement there may be repeater mode connections vertically for all the ports and horizontal repeater mode connections at varies levels. In this case all the nodes can be accessed from either sides and hence the fault location can be accurately predicted. The scan procedure is in such a way that it adds only a little overhead software to the ALDs. Most of the procedure and analysis happens at BSC 3 side. Without much additional resources “Site Scan” can be supported in ALD. Usually BSC processors and resources are enough to implement “Site Scan”.

FIG. 19 depicts the complete scan and debug sequence. The flow chart brings together all the above mentioned steps in order to better understand the invention. In particular step 1900 shows the start of the “Site Scan” at the antenna line devices or components 3, 4, 5 at the mobile base station 1. Step 1901 shows the steps of performing the site scan as explained in the linked flowchart 1902. Step 1903 shows the maintenance and operation center 2 receiving the resulting connectivity database or record and running diagnostics to assess whether or not the connectivity at the base station 1 is correct or if there is a fault, as shown in FIG. 18. Step 1904 shows the sounding of an alarm if the connectivity is not correct. An engineer can then be scheduled to be sent to the base station 1 to make the necessary repairs or physical checks. Step 1905 shows the end of the method.

The linked flowchart 1902 shows the method described in relation to FIGS. 3 to 16 in more general terms. In particular, step 1906 shows how the method progresses through the components as the scan is performed. Thus, the scan proceeds through the ports in turn. If a new component is detected, then the method proceeds to the new component as that will become the “last detected component”. An interrogation message or repeat request message is sent depending on whether the candidate component/port selected is scanned for the first time or further ports in the same component are trying to be reached. Step 1907 shows the method waiting for the response message. If no response is received, the method proceeds to step 1908 where the connectivity database is updated with the information that no response is received from the scanned port. The method proceeds to select the next component/port in step 1906. If, however, a response was received then the connectivity database can be updated and a repeat request message can be sent to establish a link to access further ports. Step 1909 shows the method waiting to determine if a repeat request message has been received and the requested link established. If not, the method returns to step 1906. If so, the method waits for the repeat mode to be established at step 1910. Step 1911 shows evaluating the connectivity at the port by sending an interrogation message. The status of the scan is also updated. Step 1912 asks whether the scan status indicates if all components/ports have been scanned. If not, the method returns to step 1906. If so, the method proceeds to step 1903.

It is remarked that the scope of protection of the invention is not restricted to the embodiments described herein. Neither is the scope of protection of the invention restricted by the reference numerals in the claims. It will be appreciated various modifications, additions and alterations may be made to the invention by one skilled in the art without departing from the spirit and scope of the invention as defined in the appended claims. The word “comprising” does not exclude other parts than those mentioned in the claims. The word “a(n)” preceding an element does not exclude a plurality of those elements. Means forming part of the invention may both be implemented in the form of dedicated hardware or in the form of a programmed purpose processor. The invention resides in each new feature or combination of features.

1. A method of determining interconnections between at least two components in a base station, the at least two components connected to each other and a plurality of components via one or more ports, the method comprising:
in response to receipt of an interrogation message at a port of one of the plurality of components, replying to said interrogation message with a response message, said response message including identification information of said component in receipt of the interrogation message.

2. A method according to claim 1, in which the response message includes one or more of the following;
a report of the number of ports present in the component in receipt of the interrogation message; and
information identifying the port of the component at which the interrogation message was received.

3. A method according to claim 1, in which the method includes the step of;
in response to receipt of a repeat request message at one of the components, configuring the component to repeat messages received at a first port to a second port, different to the first port.

4. A method according to claim 3, in which the repeat request message includes an instruction of the port to which subsequent messages should be repeated to.

5. A method according to claim 1, in which the method includes the step of;
in response to receipt of a repeat request message, said repeat request message including a request for messages to be repeated or forwarded to a particular port different to the port that received the repeat request message, replying to said repeat request message by sending one of;
a repeat request success message indicating that subsequent messages will be repeated or forwarded to the particular port; and
a repeat request failure message if a link between the port of the component that received the repeat request message and the particular port of the component requested by the repeat request message cannot be made.

6. A method according to claim 4, in which the method includes the step of;
following receipt of a repeat request message, repeating an interrogation message received at the first port to the particular port instructed in the repeat request message.

7. A method according to claim 6, in which the method includes the step of;
repeating or forwarding a response message received at the particular port to the first port.

8. A method according to claim 1, in which the method includes the step of reporting at least one discovered interconnection between the components to a remote control center.

9. A component for forming a component part of a base station, the component configured to be connected to other components by one or more ports, the component configured to;
in response to receipt of an interrogation message, reply to said interrogation message with a response message, said response message including identification information of said component.

10. A component according to claim 9, in which the response message includes one or more of the following;
a report of the number of ports present in the component; and
information identifying the port at which the interrogation message was received.

11. A component according to claim 9, in which the component is configured to, in response to receipt of a repeat request message that requests the component to repeat or forward messages to another one of its ports, configure a communication link between a first port at which the repeat request message is received and a second port, different to the first port.

12. A component according to claim 11, in which the component is configured to reply to said repeat request message with a repeat request success message indicating that a link has been established and subsequent messages will be repeated or forwarded to the particular port.

13. A component according to claim 11, in which the component is configured to, following receipt of a repeat request message, repeat a received interrogation message to the particular port instructed in the repeat request message.

14. A component according to claim 11, in which the component is configured to, following receipt of a repeat request message, repeat a response message received at the particular port to a different component.

15. A base station comprising a first component and at least one secondary component, the first and secondary components connected together via ports for providing an RF communication channel for providing a wireless communication service, wherein the first component comprises a controller component, the controller component configured to send at least one interrogation message requesting identification information from the secondary component, the secondary components configured to respond to the interrogation message with a response message, the controller component configured to receive said response message for deriving the connectivity between the components.

16. A base station as defined in claim 15, in which the base station includes a controller configured to reconfigure internal links between ports in the secondary devices and repeat messages received from the controller component along said links

17. A base station as defined in claim 16, in which each secondary component in the base station includes a controller to reconfigure internal links between its ports.

18. A method according to claim 1, comprising the steps of:
configuring the at least one of the components in a repeater mode;
performing a scan of connectivity while AISG connections are active.

19. A method according to claim 18, wherein the step of configuring at least one of the components comprise the steps of
disconnecting the component from a normal AISG scan,
connecting the components via AISG controllers in a repeating mode, in which the AISG controllers repeat messages received to other ports of the component.

20. A method according to claim 19, wherein the ports comprise transmission ports and reception ports and the step of connecting the devices via AISG controllers in a testing mode comprises cross connecting transmission and reception ports or storing and forwarding from receiving ports to transmission ports.
